(19) United States
(12) Patent Application Publication
(10) Pub. No.: US 2006/0259212 A1
(43) Pub. Date: Nov. 16, 2006

(54) Mobile robot having obstacle avoidance function and method therefor

(75) Inventor: Hyeong-shin Jeon, Gwangmyeong-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/318,450

(22) Filed: Dec. 28, 2005

(30) Foreign Application Priority Data
May 11, 2005 (KR) 10-2005-0039460

(51) Int. Cl. G01C 22/00

(52) U.S. Cl. 701/23

(57) ABSTRACT

Disclosed is a mobile robot, wherein obstacles are efficiently sensed by combining obstacle sensing signals output from different sensing units having different sensing areas and thus a drive of the mobile robot is controlled to avoid the obstacles. The mobile robot according to the present invention comprises a plurality of sensing units comprised of different sensors having different sensing areas for sensing obstacles in the traveling direction, and a microprocessor for outputting control signals according to avoidance instruction corresponding to a combination of sensing signals from the different sensors to avoid the obstacles. Accordingly, the present invention has an advantage that it is possible to recognize the obstacles with a high reliability and to avoid the obstacle efficiently, compared to when sensing the obstacles with a single kind of sensor.

### BACKGROUND OF THE INVENTION

This U.S. non-provisional patent application claims priority under 35 U.S.C. § 119 of Korean Patent Application 2005-0039460 filed on May 11, 2005, the entire contents of which are hereby incorporated by reference.

1. Field of the Invention

The present invention relates to a mobile robot, and more particularly, to a technology to efficiently sense obstacles based on obstacle sensing signals provided from different sensors, and control a driving of the mobile robot in accordance with the sensed result so as to avoid the obstacles.

2. Description of Related Art

Robots were developed for the industrial purpose and used as a part of a factory automation system. Further, the robots have been used to collect or gather information on behalf of humans in extreme environments humans cannot endure. Such a robot engineering field, while lately used in a newest space development industry, has been continuously developed, and recently human-friendly home robots have been developed. A typical example of such human-friendly home robots is a cleaning robot.

The cleaning robot that is one of mobile robots is driven for itself in a predetermined cleaning area such as a house or an office, and sucks dirt or muck. Such a cleaning robot is comprised of a traveling unit including left and right wheel motors for moving the cleaning robot, a plurality of sensors for sensing obstacles so as to move the cleaning robot without crashing against various obstacles in the cleaning area, and a microprocessor for controlling overall device, together with a general vacuum cleaner to suck the dirt or muck.

Such a cleaning robot is configured to avoid the obstacles by converting its progress direction when the obstacles are sensed via obstacle sensors installed in the robot while the cleaning robot moves in the cleaning area, and continuously clean the cleaning area.

However, since the mobile robot in the art uses only a single kind of obstacle sensor, it cannot efficiently sense the obstacles. Accordingly, the mobile robot crashes against the obstacles and gets damaged.

Therefore, the present invention was devised from the inventor's many studies on how to enhance an obstacle sensing ability of the mobile robot and then avoid the mobile robot from being crashed against the obstacles.

### SUMMARY OF THE INVENTION

The present invention provides a mobile robot having an obstacle sensing function with a higher reliability by combining sensing results from different obstacle sensors having different sensing areas and avoids the obstacles by controlling the mobile robot on the basis of the sensing results, and a method therefor.

In accordance with an aspect of the present invention, there is provided a mobile robot having a function to avoid obstacles, comprising: a plurality of sensing units comprised of different sensors having different sensing areas for sensing obstacles in the traveling direction; and a microprocessor for outputting control signals in accordance with avoidance instruction corresponding to a combination of sensing signals provided from the different sensors to avoid the obstacles.

Further, the different sensors used in the sensing unit are consisted of an infrared sensor and an ultrasonic sensor.

Accordingly, the present invention has an advantage that it is possible to recognize the obstacles with a high reliability and also avoid the obstacle efficiently, compared to when sensing the obstacles using a single kind of sensor.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a cleaning robot that is one example of a mobile robot having a function of avoiding obstacles in accordance with a preferred embodiment of the present invention;

FIG. 2a is an outline view showing a front part of the cleaning robot having the sensing unit shown in FIG. 1;

FIG. 2b is an outline view showing obstacle sensing areas of the sensing unit shown in FIG. 2a; and

FIG. 3 is a flowchart schematically illustrating a procedure that a cleaning robot that is one example of a mobile robot in accordance with a preferred embodiment of the present invention senses and avoids an obstacle.

### DETAILED DESCRIPTION OF THE INVENTION

Hereinafter, exemplary embodiments according to the present invention will now be described in detail with reference to the accompanying drawings.

Further, a description will be given under the assumption that the mobile robot of the present invention is a cleaning robot that is a typical example of the mobile robot.

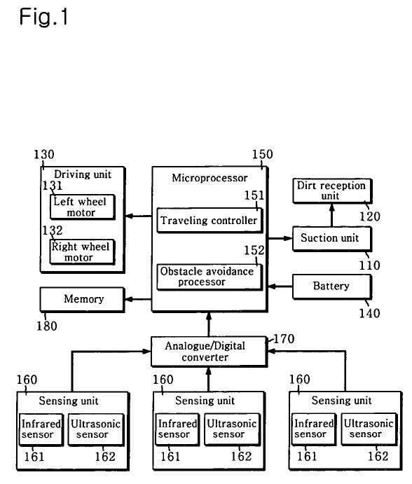

FIG. 1 is a block diagram illustrating a cleaning robot of a mobile robot having a function of avoiding obstacles in accordance with a preferred embodiment of the present invention. Referring to FIG. 1, the cleaning robot having a function of avoiding obstacles in accordance with the present invention is comprised of a plurality of sensing units 160, each of which is consisted of a pair of sensors having different sensing areas, respectively, the unit outputting a sensing signal based on an obstacle sensing while moving, a driving unit 130 including left and right wheel motors 131 and 132 for moving the cleaning robot, a memory 180 for storing an operation program of the cleaning robot and a plurality of avoidance instructions, a microprocessor 150 including a traveling controller 151 for controlling a driving of the driving unit 130, the microprocessor controlling the overall devices of the cleaning robot, together with a basic configuration of the cleaning robot.

The basic configuration of the cleaning robot is comprised of a suction unit 110 having a dirt sensor for sensing dirt or muck in a cleaning area, for sucking the dirt or muck sensed by the dirt sensor, a dirt reception unit 120 for receiving the dirt or muck collected by the suction unit 110, a driving unit 130 including left and right wheel motors 131 and 132 for moving the cleaning robot according to input control signals, a battery 140 for supplying a driving power for the suction unit 110 and the driving unit 130, and a microprocessor 150 for controlling the overall devices of the cleaning robot. Since such a basic configuration of the cleaning robot is well known in the art, the detailed description thereof will be omitted.

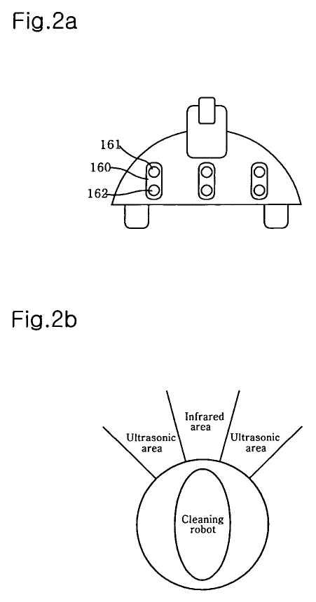

The sensing unit 160 is consisted of a pair of different sensors having different sensing areas, respectively, that is, an infrared sensor 161 for sensing obstacles in the traveling direction using infrared light, and an ultrasonic sensor 162 for irradiating ultrasonic waves and sensing obstacles in the traveling direction, each sensor providing a sensing signal when it senses the obstacles. A detailed description of the sensing unit 160 will be given below with reference to FIGS. 2a and 2b.

FIG. 2a is an outline view showing a front portion of the cleaning robot having the sensing unit shown in FIG. 1, and FIG. 2b is an outline view showing obstacle sensing areas of the sensing unit shown in FIG. 2a. As shown in FIG. 2a, a plurality of the sensing units 160 in accordance with a preferred embodiment of the present invention are arranged in front part of the cleaning robot at a predetermined interval, each sensing unit 160 having a pair of an infrared sensor 161 for sensing obstacles in the traveling direction using infrared rays, and an ultrasonic sensor 162 for sensing obstacles in the traveling direction by irradiating ultrasonic waves.

The infrared sensor 161 is consisted of an emitter for irradiating the infrared rays and a receiver for receiving the infrared rays reflected on the obstacles and returned, wherein since it uses light having a property of collimation, its sensing area is narrow but it is possible to sense correct positions of the obstacles. It is apparent that such an infrared sensor 161 is technically well known.

For reference, each object has an inherent reflectivity for the infrared rays. Accordingly, a small amount of infrared rays is reflected compared to the originally irradiated infrared rays due to absorption and diffused reflection on the obstacle, wherein the infrared sensor 161 senses whether there exist the obstacles using the reflected infrared rays and calculates a distance to the obstacles by measuring a time from when the emitter irradiates the infrared light until the reflected light is inputted to the receiver.

The ultrasonic sensor 162 is consisted of an ultrasonic radiator for irradiating ultrasonic waves and an ultrasonic receiver for receiving reflected waves returned from the obstacles. Since the ultrasonic sensor 162 makes use of sonic waves, it has a large sensing area but it cannot detect correct positions of the obstacles. Such an ultrasonic sensor 162 senses whether there exist the obstacles using signals reflected on the obstacles and received, and calculates a distance between the obstacles and the cleaning robot using a time from when the radiator irradiates the ultrasonic waves until it receives the reflected waves.

Since the infrared sensor 161 detects the obstacles using the infrared rays as set forth above, that is, a kind of light, it has a drawback in that its sensing area is narrow compared to the ultrasonic sensor 162. Further, since the ultrasonic sensor 162 uses the sonic waves, it has a broader sensing area than that of the infrared sensor 161. However, the ultrasonic sensor 162 has a high interference from an external noise; and therefore, it is difficult to correctly sense the obstacles compared to the infrared sensor 161.

Accordingly, the cleaning robot in accordance with the present invention has an advantage in that it senses the obstacles by combining outputs of the infrared and ultrasonic sensors 161 and 162 having different sensing areas, thereby enabling a superior obstacle sensing compared to a conventional cleaning robot.

A sensing signal provided from the sensing unit 160 and transmitted to the microprocessor 150 may be a voltage level. Accordingly, it is needed to convert such sensing signal into a digital signal suitable for the microprocessor 150 of a digital device.

An analogue/digital converter 170 converts a voltage signal that is a sensing signal outputted from the sensing unit 160 into a digital signal suitable for the microprocessor 150 of a digital device. At this time, the converted digital signal may have a different value depending on the sensing signal provided from the sensing unit 160.

The memory 180 may be a nonvolatile memory with which data can be read and written, such as EEPROM and flash memory, and operation program and related data to drive the cleaning robot are stored therein. The data stored in the memory 180 is accessed and controlled by the microprocessor 150. According to an aspect of the present invention, the memory 180 stores a plurality of avoidance instructions corresponding to a combination of sensing signals provided from the different sensing units, that is, the infrared sensor 161 and the ultrasonic sensor 162.

For example, a combination of sensing signals provided from the infrared sensor 161 and the ultrasonic sensor 162 may be classified into following cases: a case where both of the infrared sensor 161 and the ultrasonic sensor 162 do not output the sensing signal at all, a case where the infrared sensor 161 only outputs the sensing signal, a case where the ultrasonic sensor 162 only outputs the sensing signal, and both of the infrared sensor 161 and the ultrasonic sensor 162 output the sensing signal.

The plurality of avoidance instructions may include an instruction indicating “go straight ahead continuously” in the case that both of the infrared sensor 161 and the ultrasonic sensor 162 do not output the sensing signal, and an instruction indicating “slow down and turn left or right” in the case that the infrared sensor 161 only outputs the sensing signal.

Further, the avoidance instructions may include an instruction indicating “slow down and go straight ahead continuously” in the case that the ultrasonic sensor 162 only outputs the sensing signal, and an instruction indicating “stop and turn” in the case that both of the infrared sensor 161 and the ultrasonic sensor 162 output the sensing signal.

It should be noted that such avoidance instructions are not limited to the above cases but can be variously embodied by developers.

The microprocessor 150 includes a traveling controller 151 for controlling the overall devices of the cleaning robot and a driving of the driving unit 130 in response to an input control signal, and an obstacle avoidance processor 152 for accessing an avoidance instruction from the memory 180 corresponding to a combination of the sensing signals provided form the sensing unit 160, and outputting a control signal to the traveling controller 151 so as to move the cleaning robot according to the accessed avoidance instruction.

The traveling controller 151 controls the driving unit 130 for moving the cleaning robot according to the operation program of the cleaning robot.

The obstacle avoidance processor 152 receives the sensing signals from the sensing unit 160 so as to recognize whether the obstacles exist or not, and accesses to the memory 180 to thereby output avoidance instructions corresponding to the combination of the sensing signals to the traveling controller 151.

That is, the obstacle avoidance processor 152 accesses the memory 180 to provide the traveling controller 151 with avoidance instructions corresponding to the cases that both of the infrared sensor 161 and the ultrasonic sensor 162 do not output the sensing signal at all, the infrared sensor 161 only outputs the sensing signal, the ultrasonic sensor 162 only outputs the sensing signal, and both of the infrared sensor 161 and the ultrasonic sensor 162 output the sensing signal.

As described above, the avoidance instruction may be an instruction indicating “go straight ahead continuously” in the case that both of the infrared sensor 161 and the ultrasonic sensor 162 do not output the sensing signal, and an instruction indicating “slow down and turn left or right” in the case that the infrared sensor 161 only outputs the sensing signal.

Further, the avoidance instruction may be an instruction instructing “slow down and go straight ahead continuously” in the case that the ultrasonic sensor 162 only outputs the sensing signal, and an instruction indicating “stop and turn” in the case that both of the infrared sensor 161 and the ultrasonic sensor 162 output the sensing signal.

Such avoidance instructions are accessed from the memory 180 by the obstacle avoidance processor 152 of the microprocessor 150 and then provided to the traveling controller 151. The traveling controller 151 controls the driving of the left and right wheel motors 131 and 132 of the driving unit 130 according to the avoidance instructions so as to avoid the obstacles and perform the cleaning function continuously.

Accordingly, the present invention has an advantage in that it is possible to recognize the obstacles with a high reliability and avoid the obstacles efficiently, compared to when sensing the obstacles with a single kind of sensor.

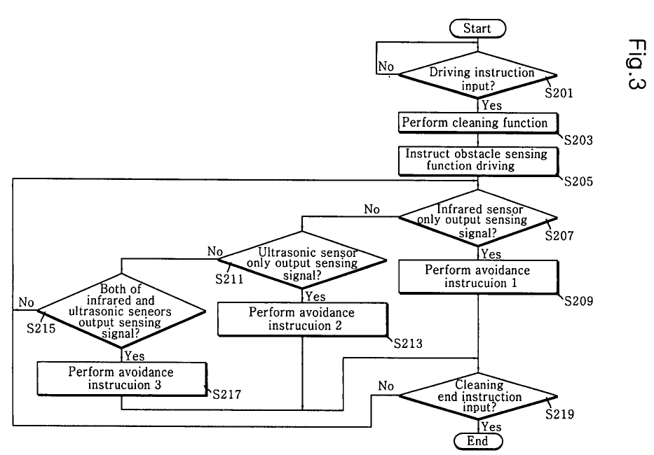

FIG. 3 is a flowchart schematically illustrating a procedure that a cleaning robot of a mobile robot in accordance with one embodiment of the present invention senses and avoids an obstacle. Referring to FIG. 3, when a user inputs a driving instruction of the cleaning robot (S201), an operation program outputs a control signal to the traveling controller 151 according to the user's driving instruction and moves the cleaning robot. At the same time, the operation program drives the suction unit 110 to perform the cleaning function while randomly moving the cleaning area (S203).

Further, the operation program outputs the driving instruction to the plurality of sensing units 160 installed in front part of the cleaning robot to sense whether or not the obstacles exist while the cleaning robot is moving (S205).

The sensing unit 160 has a pair of the infrared sensor 161 and the ultrasonic sensor 162, which irradiate infrared rays and ultrasonic waves, respectively, and sense whether the obstacles exist or not.

When the obstacle is sensed by the infrared sensor 161 and/or the ultrasonic sensor 162, the corresponding infrared sensor 161 and/or ultrasonic sensor 162 provide the analogue/digital converter 170 with an obstacle sensing signal which is an analogue signal, such as voltage. The analogue/digital converter 170 converts an input sensing signal into a digital signal and outputs the same to the obstacle avoidance processor 152 of the microprocessor 150. At this time, the digital signal to the obstacle avoidance processor 152 may be, for example, binary data. In the case that the infrared sensor 161 outputs a sensing signal and the ultrasonic sensor 162 does not output a sensing signal, for example, the analogue/digital converter 170 outputs a digital signal “10”.

The obstacle avoidance processor 152 accesses an avoidance instruction, based on the combination of the sensing signals from the corresponding infrared sensor 161 and ultrasonic sensor 162, which is stored in the memory 180, according to the digital signal received from the analogue/digital converter 170.

The avoidance instruction stored in the memory 180 may be a traveling instruction indicating “go straight ahead continuously” in the case that both of the infrared sensor 161 and the ultrasonic sensor 162 do not output the sensing signal, an avoidance instruction 1 indicating “slow down and turn left or right” in the case that the infrared sensor 161 only outputs the sensing signal, an avoidance instruction 2 indicating “slow down and go straight ahead continuously” in the case that the ultrasonic sensor 162 only outputs the sensing signal, and an avoidance instruction 3 indicating “stop and turn” in the case that both of the infrared sensor 161 and the ultrasonic sensor 162 output the sensing signal.

That is, when the obstacle avoidance processor 152 receives a digital signal “10” from the analogue/digital converter 170 (S207), it accesses the avoidance instruction 1 indicating “slow down and turn left or right” from the memory 180 and transmits the instruction 1 to the traveling controller 151.

The traveling controller 151 outputs a control signal to the driving unit 130 in order to run the cleaning robot according to the avoidance instruction 1 received from the obstacle avoidance processor 152.

The driving unit 130 controls the driving of the left or right wheel motor 131 or 132 in response to the control signal from the traveling controller 151 to slow down the speed of the cleaning robot and turn the traveling direction of the cleaning robot left or right so that the cleaning robot can avoid the sensed obstacle (S209).

Further, in the case where the ultrasonic sensor 162 only outputs the sensing signal (S211), the analogue/digital converter 170 outputs a digital signal “01”. The obstacle avoidance processor 152 accesses the avoidance instruction 2 from the memory 180 and transmits it to the traveling controller 151, the instruction 2 indicating “slow down and go straight ahead continuously” according to the digital signal “01” transmitted from the analogue/digital converter 170.

The traveling controller 151 outputs a control signal to the driving unit 130 in order to run the cleaning robot according to the avoidance instruction 2 received from the obstacle avoidance processor 152. The driving unit 130 controls the driving of the left or right wheel motor 131 or 132 according to the control signal from the traveling controller 151 to go straight ahead the cleaning robot while slowing down the speed thereof (S213).

When the infrared sensor 161 as well as the ultrasonic sensor 162 outputs the sensing signal while going straight according to the corresponding instruction (S215), the analogue/digital converter 170 outputs a digital signal “11”. The obstacle avoidance processor 152 accesses, from the memory 180, the avoidance instruction 3 indicating “stop and turn” according to the digital signal “11” transmitted from the analogue/digital converter 170 and transmits the avoidance instruction 3 to the traveling controller 151. The traveling controller 151 outputs a control signal to the driving unit 130 in order to run the cleaning robot according to the avoidance instruction 3 received from the obstacle avoidance processor 152.

The driving unit 130 controls the drive of the left or right wheel motor 131 or 132 to stop the cleaning robot, turn left or right and then go straight according to the control signal output from the traveling controller 151 so that the cleaning robot can avoid the sensed obstacle (S217). The cleaning robot repeats the processes as described above until the user inputs an end instruction (S219).

In the mobile robot having an obstacle avoidance function and method therefor in accordance with the present invention, an advantage is that since the obstacle is sensed by combining outputs of the infrared and ultrasonic sensors having different sensing areas, it has an excellent obstacle sensing function, compared to a conventional mobile robot sensing the obstacle with a single kind of sensor which has one sensing area.

Further, it is possible to avoid the obstacles efficiently by applying different avoidance algorithms according to a combination of sensing signals from the infrared and ultrasonic sensors.

While the present invention has been described with reference to exemplary embodiments thereof, it will be understood by those skilled in the art that various changes in form and details may be made therein without departing from the scope of the present invention as defined by the following claims.

What is claimed is:

1. A mobile robot comprising:
a sensing unit comprised of a plurality of different sensors having different sensing areas for sensing obstacles.

2. The mobile robot according to claim 1, wherein the sensing unit includes an infrared sensor and an ultrasonic sensor.

3. The mobile robot according to claim 2, further comprising a microprocessor for outputting control signals to avoid the obstacles in accordance with avoidance instructions corresponding to a combination of sensing signals outputted from each of the different sensors of the sensing unit.

4. The mobile robot according to claim 3, wherein the avoidance instructions are classified into an instruction in case where both of the infrared sensor and the ultrasonic sensor output or do not output the sensing signal, and an instruction in case where one of the infrared sensor and the ultrasonic sensor outputs the sensing signal.

5. The mobile robot according to claim 4, wherein the avoidance instructions comprise a traveling instruction indicating “go straight ahead continuously” in case where both of the infrared sensor and the ultrasonic sensor do not output the sensing signal, an avoidance instruction 1 indicating “slow down and turn left or right” in case where the infrared sensor only outputs the sensing signal, an avoidance instruction 2 indicating “slow down and go straight ahead continuously” in case where the ultrasonic sensor only outputs the sensing signal, and an avoidance instruction 3 indicating “stop and turn” in case where both of the infrared sensor and the ultrasonic sensor output the sensing signal.

6. The mobile robot according to claim 3, further comprising a memory for storing the avoidance instructions.

7. The mobile robot according to claim 6, wherein the microprocessor comprises an obstacle avoidance processor for accessing the memory to obtain the avoidance instructions corresponding to the combination of the sensing signals provided from each of the different sensors and outputting control signals to avoid the obstacles in accordance with the accessed avoidance instructions.

8. The mobile robot according to claim 7, wherein the obstacle avoidance processor transmits a signal to control a driving unit to a traveling controller to avoid the obstacles.

9. A mobile robot comprising:
a sensing unit comprised of a plurality of different sensors having different sensing areas for sensing obstacles;
a microprocessor for controlling a driving unit based on sensing signals outputted from the sensing unit;
a suction unit for sucking a dirt; and
a dirt reception unit for filtering and receiving the dirt sucked by the suction unit.

10. The mobile robot according to claim 9, wherein the sensing unit include an infrared sensor and an ultrasonic sensor.

11. The mobile robot according to claim 10, further comprising a microprocessor for outputting control signals to avoid the obstacles in accordance with avoidance instructions corresponding to a combination of the sensing signals outputted from each of the different sensors of the sensing unit.

12. The mobile robot according to claim 11, wherein the avoidance instructions are classified into an instruction in case where both of the infrared sensor and the ultrasonic sensor output or do not output the sensing signal, and an instruction in case where one of the infrared sensor and the ultrasonic sensor outputs the sensing signal.

13. The mobile robot according to claim 12, wherein the avoidance instructions comprise a traveling instruction indicating “go straight ahead continuously” in case where both of the infrared sensor and the ultrasonic sensor do not output the sensing signal, an avoidance instruction 1 indicating “slow down and turn left or right” in case where the infrared sensor only outputs the sensing signal, an avoidance instruction 2 indicating “slow down and go straight ahead continuously” in case where the ultrasonic sensor only outputs the sensing signal, and an avoidance instruction 3 indicating “stop and turn” in case where both of the infrared sensor and the ultrasonic sensor output the sensing signal.

14. The mobile robot according to claim 11, further comprising a memory for storing the avoidance instructions.

15. The mobile robot according to claim 14, wherein the microprocessor comprises an obstacle avoidance processor for accessing the memory to obtain the avoidance instructions corresponding to the combination of the sensing signals provided from each of the different sensors and outputting control signals to avoid the obstacles in accordance with the accessed avoidance instructions.

16. The mobile robot according to claim 15, wherein the obstacle avoidance processor transmits a signal to control a driving unit to a traveling controller to avoid the obstacles.

17. A method for controlling a mobile robot, the method comprising the steps of:
(a) receiving sensing signals outputted from different sensors having different sensing areas;
(b) accessing a memory to obtain avoidance instructions corresponding to a combination of the sensing signals outputted from the sensors; and
(c) controlling a driving unit in accordance with the accessed avoidance instructions.

18. The method according to claim 17, wherein the different sensors include an infrared sensor and an ultrasonic sensor.

19. The method according to claim 17, wherein the avoidance instructions at said step (b) are classified into an instruction in case where both of the infrared sensor and the ultrasonic sensor output or do not output the sensing signal, and an instruction in case where one of the infrared sensor and the ultrasonic sensor outputs the sensing signal.

20. The method according to claim 19, wherein the avoidance instructions comprise a traveling instruction indicating “go straight ahead continuously” in case where both of the infrared sensor and the ultrasonic sensor do not output the sensing signal, an avoidance instruction 1 indicating “slow down and turn left or right” in case where the infrared sensor only outputs the sensing signal, an avoidance instruction 2 indicating “slow down and go straight ahead continuously” in case where the ultrasonic sensor only outputs the sensing signal, and an avoidance instruction 3 indicating “stop and turn” in case where both of the infrared sensor and the ultrasonic sensor output the sensing signal.
